(19) United States
(12) Patent Application Publication
(10) Pub. No.: US 2025/0361429 A1
(43) Pub. Date: Nov. 27, 2025

(54) ADHESIVE FILM, ADHESIVE MEMBER COMPRISING THE SAME AND METHOD FOR BONDING USING THE SAME

(71) Applicant: Industry-Academic Cooperation Foundation, Yonsei University, Seoul (KR)

(72) Inventors: Jungmok SEO, Seoul (KR); Yejin JO, Seoul (KR); Yurim LEE, Seoul (KR)

(73) Assignee: Industry-Academic Cooperation Foundation, Yonsei University, Seoul (KR)

(21) Appl. No.: 19/216,087

(22) Filed: May 22, 2025

(30) Foreign Application Priority Data
May 23, 2024 (KR) 10-2024-0067301
Apr. 30, 2025 (KR) 10-2025-0057540

(51) Int. Cl. C09J 129/04; C09J 5/06; C09J 199/00

(52) U.S. Cl. CPC C09J 129/04; C09J 5/06; C09J 199/00; C09J 2203/326; C09J 2301/208; C09J 2429/00; C09J 2499/00

(57) ABSTRACT

Disclosed are an adhesive film which may be applied to not only rigid electronic devices but also soft electronic devices by having excellent mechanical strength and adhesive strength due to hydrogen bonding and galloyl interaction, as well as high transparency, coating uniformity, and flexibility, an adhesive member including the same, and a bonding method using the same.

### BACKGROUND

### 1. Technical Field

The present disclosure relates to an adhesive film having excellent mechanical strength and adhesive strength due to hydrogen bonding and galloyl interaction, an adhesive member comprising the same, and method for bonding using the same.

### 2. Related Art

Soft electronics have received significant attention due to their potential to revolutionize human-machine interaction by bridging the mechanical disparity between traditional rigid electronics and soft tissues.

These soft electronic devices may be composed of soft components and rigid components. The soft components of the soft electronic devices usually comprise stretchable and flexible polymers and hydrogels, serving as deformable substrates, interconnectors, and electrodes. These soft components of the soft electronic device facilitate the conformal contact between the device and the human body, allowing reliable sensing of various biological signals or stimulation of body tissue. In particular, many studies have developed hydrogel-based electronic devices by exploiting the distinctive properties of hydrogels, including their high water content, low Young's modulus, and biocompatibility.

However, the realization of soft electronics with only soft components is considered infeasible due to limitations in data processing or transmission operations. Therefore, the use of rigid components such as IC chips or printed circuit boards (PCBs) is essential. These soft components and rigid components should be seamlessly integrated and robustly combined for the reliable operation of the devices under dynamic movement conditions.

However, achieving stable integration is challenging due to their inherent differences in chemical and mechanical properties. For instance, the strong adhesion of hydrogels (wet materials) to other dry materials is difficult owing to their high water content, which hinders intimate contact and adhesion between them.

Therefore, in order to overcome the above-described problems, the inventors of the present disclosure have recognized the urgent need for development of a technology capable of flexible and robust bonding not only between the same materials but also between different materials, thereby completing the present disclosure.

### PRIOR ART DOCUMENTS

### Patent Documents

(Patent Document 1) Korean Patent No. 10-2250571

### Non-Patent Documents

(Non-Patent Document 1) Solution-processable, soft, self-adhesive, and conductive polymer composites for soft electronics, Nature Communications, volume 13, Article number: 358 (2022).

### SUMMARY

An object of the present disclosure is to provide an adhesive film which may be applied to not only rigid electronic devices but also soft electronic devices by having excellent mechanical strength and adhesive strength due to strong hydrogen bonding and galloyl interaction, as well as high transparency, coating uniformity, and flexibility, and an adhesive member including the same.

Another object of the present disclosure is to provide a bonding method using an adhesive member including an adhesive film that enables flexible and robust bonding not only between the same materials but also between different materials.

Still another object of the present disclosure is to provide a soft device that may be applied to various fields by having excellent flexibility and biocompatibility.

The objects of the present disclosure are not limited to the objects mentioned above, and other technical objects not mentioned will be clearly understood by those skilled in the art to which the present disclosure pertains from the description below.

In order to achieve the above objects, according to one aspect of the present disclosure, there is provided an adhesive film including: a first adhesive layer including a polyphenol-based compound; and a composite layer formed on the first adhesive layer, wherein the composite layer includes repeating unit consisting of: a resin layer including a hydrophilic polymer; and a second adhesive layer formed on the resin layer and including a polyphenol-based compound.

According to another aspect of the present disclosure, there is provided an adhesive member including: a substrate; and the adhesive film formed on the substrate, wherein the adhesive film is positioned such that the first adhesive layer is adjacent to the substrate.

According to still another aspect of the present disclosure, there is provided a method for fabricating an adhesive member, including steps of: forming a first adhesive layer on a substrate by coating with a solution containing a polyphenol-based compound; and forming a composite layer on the first adhesive layer; wherein the step of forming the composite layer includes repeating, once or more, steps of: forming a resin layer by coating with a solution containing a hydrophilic polymer; and forming a second adhesive layer on the resin layer by coating with a solution containing a polyphenol-based compound.

According to yet another aspect of the present disclosure, there is provided a bonding method including a step of bonding the adhesive member and a substrate together.

According to still yet another aspect of the present disclosure, there is provided a soft device including the adhesive member.

The adhesive film and the including adhesive member the same according to one embodiment of the present disclosure may be applied to not only rigid electronic devices but also soft electronic devices by having excellent mechanical strength and adhesive strength due to strong hydrogen bonding and galloyl interaction, as well as high transparency, coating uniformity, and flexibility.

The bonding method using an adhesive member including an adhesive film according to another embodiment of the present disclosure enables flexible and robust bonding not only between the same materials but also between different materials.

The soft device including an adhesive member according to still another embodiment of the present disclosure may be applied to various fields by having excellent flexibility and biocompatibility.

The effects of the present disclosure are not limited to the effects mentioned above, and effects not mentioned will be clearly understood by those skilled in the art from the present specification and the accompanying drawings.

### BRIEF DESCRIPTION OF THE DRAWINGS

FIG. 1 is an image schematically showing a method for fabricating an adhesive member including an adhesive film according to one embodiment of the present disclosure.

FIG. 2 shows a spectrum analyzed by ATR-FTIR spectroscopy (ATR-FTIR spectroscopy, Vertex 70, Bruker, USA) for an adhesive member including an adhesive film according to Example 1 of the present disclosure.

FIG. 3 shows laser confocal microscope (VK-X3050, Keyenece) and atomic force microscope (AFM, NX-10, Park Systems) images of an adhesive member including an adhesive film according to Example 1 of the present disclosure.

FIG. 4 shows a cross-cut adhesion test method for adhesive members including an adhesive film according to Examples 1 and 4 of the present disclosure and optical images of the adhesive members for which the test has been performed.

FIG. 5 shows the UV-Vis spectrophotometer (V-650, JASCO) spectra showing the transparency of an adhesive member (glass substrate, red line, d-HAPT) including an adhesive film according to Example 1 of the present disclosure, a member coated with a PVA/TA mixed solution (glass substrate, green line, Mixed), and a bare glass substrate, and shows optical images thereof.

FIG. 6 is an image schematically showing a method of forming a bonded structure (DD bonded structure) by bonding an adhesive member and a dry substrate together according to the present disclosure.

FIG. 7 shows an optical image of an adhesive member-dry substrate bonded structure 1 (DD bonded structure 1) and a scanning electron microscope image of the cross-section of DD bonded structure 1 according to Example 5 of the present disclosure.

FIG. 8 is an image and graph showing the bonding strength of adhesive member-dry substrate bonded structures 2a to 2c (DD bonded structures 2a to 2c) fabricated by bonding identical metal substrate/substrate according to Example 6 of the present disclosure.

FIG. 9 is a graph showing the bonding strength of adhesive member-dry substrate bonded structures 3a to 3c (DD bonded structures 3a to 3c) fabricated by bonding identical polymer substrate/substrate according to Example 7 of the present disclosure.

FIG. 10 is a graph showing the bonding strength of adhesive member-dry substrate bonded structures 4a and 4b (DD bonded structures 4a and 4b) fabricated by bonding different substrate/substrate according to Example 8 of the present disclosure.

FIG. 11 is an image schematically showing a method of forming a bonded structure (WD bonded structure) by bonding an adhesive member and a wet substrate together according to the present disclosure.

FIG. 12 is images demonstrating the mechanical robustness of adhesive member-wet substrate bonded structure 1 (WD bonded structure 1) according to Example 9 of the present disclosure and PAAm-alginate hydrogel (Preparation Example 6).

FIG. 13 is a graph showing the bonding strengths of adhesive member-wet substrate bonded structures (WD bonded structures 2 to 4) according to Examples 10 to 12 of the present disclosure and comparative bonded structures.

FIG. 14 shows a stretchable circuit system fabricated by applying an adhesive member-wet substrate (conductive CNT hydrogel) bonded structure according to the present disclosure, and images showing the results of confirming whether the stretchable circuit system operates and the stretchability thereof.

FIG. 15 is images schematically showing a method of fabricating a wearable touch panel by bonding an adhesive member 2 (Example 2) and an ionic hydrogel together according to the present disclosure and the operating principle of the wearable touch panel.

FIG. 16 is a graph of current change that shows the results of examining the operation of a wearable touch panel (Experimental Example 7) fabricated by applying adhesive member 2 (Example 2) according to the present disclosure.

FIG. 17 is images showing a schematic method and results for a test for the reflection of the touch on the monitor in which current data of a wearable touch panel (Experimental Example 7) fabricated by applying adhesive member 2 (Example 2) according to the present disclosure was converted into position data and applied.

FIG. 18 shows an image of a wearable sensor fabricated by bonding adhesive member 4e (Example 4) according to the present disclosure and a conductive CNT hydrogel together, and graphs showing the results of examining whether the wearable sensor operates depending on joint bending.

FIG. 19 shows images of a wearable dual sensor fabricated by applying adhesive member 2 (Example 2, PDMS) according to the present disclosure, and graphs showing resistance and pressure characteristics according to the distance from a heat source in the wearable dual sensor.

FIG. 20 is images and graphs showing cell viability and morphological changes in an in vitro experiment using adhesive member 4a (Example 4, Coated PI) according to the present disclosure.

FIG. 21 is images and graphs showing the results of evaluating the histological morphology and hepatotoxicity of adhesive member 2 (Example 2, PDMS) according to the present disclosure applied to an in vivo experiment.

FIG. 22 is images and graphs showing the fabrication of an implantable bioelectronic device using adhesive member 2 (Example 2, PDMS) according to the present disclosure, the implantation of the device into a living body (mouse), and the results of evaluating the nerve control ability in the sciatic nerve and electrocardiogram transmission ability of the device.

### DETAILED DESCRIPTION

Hereinafter, the present disclosure will be described in detail with reference to the accompanying drawings.

Throughout the present specification, it is to be understood that when any part is referred to as “including” any component, it does not exclude other components, but may further include other components, unless otherwise specified.

Throughout the present specification, when any member is referred to as being “on” another member, it not only refers to a case where any member is in contact with another member, but also a case where a third member exists between the two members.

Throughout the present specification, terms including ordinal numbers, such as “first” and “second”, are used only for the purpose of distinguishing one component from another component, and are not limited by the ordinal numbers.

In the detailed description of the principles of preferred embodiments of the present disclosure, when the detailed description of a related known function or configuration is determined to unnecessarily obscure the subject matter of the present disclosure, it may be omitted.

### Adhesive Film and Adhesive Member Including the Same

According to one aspect of the present disclosure, there is s provided an adhesive film including: a first adhesive layer including a polyphenol-based compound; and a composite layer formed on the first adhesive layer; wherein the composite layer includes a repeating unit consisting of: a resin layer including a hydrophilic polymer; and a second adhesive layer formed on the resin layer and including a polyphenol-based compound.

More specifically, then adhesive film according to one embodiment of the present disclosure includes: a first adhesive layer; and a composite layer, wherein the composite layer includes a repeating unit consisting of: a resin layer formed adjacent to the first adhesive layer; and a second adhesive layer positioned on the resin layer.

According to one embodiment of the present disclosure, the composite layer may include 2 or more repeating units. More specifically, the composite layer may include 2 or more, 3 or more, 4 or more, or 5 or more repeating units, and may include 10 or less, 9 or less, 8 or less, 7 or less, or 6 or less repeating units. As the composite layer includes the above-described number of repeating units, it may satisfy both high transparency and excellent mechanical strength, and may increase adhesion by preventing the formation of micro-irregularities.

According to one embodiment of the present disclosure, the polyphenol-based compounds included in the first adhesive layer and the second adhesive layer may be each independently at least one selected from the group consisting of tannic acid (TA), gallic acid (GA), and flavonoid (proanthocyanidin), and preferably least one selected from the group consisting of tannic acid and gallic acid.

According to one embodiment of the present disclosure, the hydrophilic polymer may be at least one selected from the group consisting of polyvinyl alcohol (PVA), gelatin methacryloyl (GelMA), chitosan, and alginate, and preferably at least one selected from the group consisting of polyvinyl alcohol and alginate.

According to one embodiment of the present disclosure, the interface between the first adhesive layer and the composite layer, and the interface between the resin layer and the second adhesive layer in the composite layer may be formed by hydrogen bonding.

More specifically, in the present disclosure, hydrogen bonds are formed at the interface between the first adhesive layer and the composite layer, that is, the interface between the first adhesive layer and the resin layer of the composite layer, and the interface between the resin layer and the second adhesive layer in the composite layer. As the hydrogen bonds are formed, the adhesive film according to the present disclosure may have excellent mechanical strength.

For example, when the first adhesive layer and the second adhesive layer include tannic acid (TA) and the resin layer includes polyvinyl alcohol (PVA), a hydrogen bond may be formed between the oxygen atom of the tannic acid and the hydroxyl group (—OH) of the polyvinyl alcohol, and the layers may be strongly bonded by the hydrogen bond, thereby improving the mechanical strength of the adhesive film according to the present disclosure.

The adhesive film according to one embodiment of the present disclosure may have excellent mechanical strength through strong hydrogen bonding, and may be formed to have a stacked structure with a controlled thickness, thereby maintaining high transparency.

According to another aspect of the present disclosure, there is provided an adhesive member including: a substrate; and an adhesive film formed on the substrate; wherein the adhesive film is positioned such that the first adhesive layer is adjacent to the substrate.

In the present disclosure, the substrate may be a metal, polymer or hydrogel substrate.

More specifically, the metal substrate may include stainless steel (SS), aluminum (Al), copper (Cu), iron (Fe), or an alloy of two or more thereof, the polymer substrate may be a substrate made of polyimide (PI), acrylic resin, polypropylene (PP), thermoplastic polyurethane (TPU), Eco-flex, polydimethylsiloxane (PDMS), or a mixture of two or more thereof, and the hydrogel substrate may be a substrate including a hydrogel made of poly(vinyl alcohol, PVA), tannic acid (TA), acrylamide (AAm), N,N′-methylenebis(acrylamide, MBAA), LiCl, alginate, or a mixture of two or more thereof.

In the present disclosure, the substrate may be in the form of a sheet, plate, cable or block, but is not limited thereto and may be in any form that does not affect the physical or chemical properties of the adhesive member according to the present disclosure when applied to the adhesive member.

According to one embodiment of the present disclosure, the adhesive film may be adhered to the substrate by galloyl interaction.

More specifically, the first adhesive layer of the adhesive film is positioned adjacent to the substrate and adhered thereto, and the hydroxyl group (—OH), the phenyl group, and the oxygen atom (O) of the polyphenol-based compound constituting the first adhesive layer form hydrogen bonds, hydrophobic interactions, π-π interactions, and metal coordination with the substrate, respectively, so that the adhesive film may be strongly adhered to the substrate by galloyl interactions, whereby the adhesive strength between the adhesive film and the substrate of the adhesive member according to the present disclosure may be increased.

The adhesive member including an adhesive film according to one embodiment of the present disclosure may have excellent mechanical strength and adhesive strength due to hydrogen bonding between the adhesive layer and the resin layer and galloyl interaction between the adhesive layer and the substrate, and may maintain high transparency and flexibility by forming the adhesive film to have a stacked structure with a controlled thickness.

According to another aspect of the present disclosure, there is provided a method for fabricating an adhesive member, including steps of: forming a first adhesive layer on a substrate by coating with a solution containing a polyphenol-based compound; and forming a composite layer on the first adhesive layer.

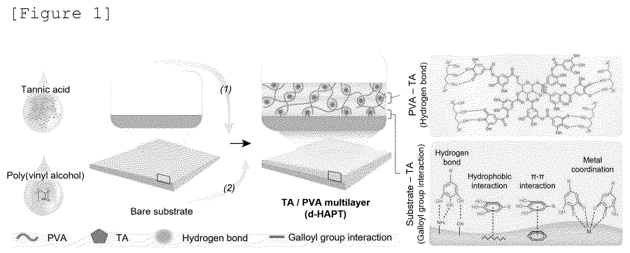

FIG. 1 is an image schematically showing a method for fabricating an adhesive member including an adhesive film according to one embodiment of the present disclosure.

As shown in FIG. 1, a first adhesive layer (tannic acid, TA) including a polyphenol-based compound is formed on a substrate, and a composite layer is formed on the first adhesive layer, wherein the composite layer is composed of: a resin layer (poly(vinyl alcohol, PVA) including a hydrophilic polymer; and a second adhesive layer (TA) formed on the resin layer and including a polyphenol-based compound. In this case, the adhesive member may exhibit excellent adhesive properties by galloyl interaction at the interface between the substrate and the first adhesive layer, and exhibit excellent mechanical strength by hydrogen bonds formed at the interface between the adhesive layer and the resin layer.

According to one embodiment of the present disclosure, the step of forming the first adhesive layer on the substrate may include steps of: coating the substrate with a solution containing a polyphenol-based compound; and drying the substrate coated with the solution to form the first adhesive layer, and the step of forming the composite layer may include repeating, once or more, steps of forming the resin layer by coating with a solution containing a hydrophilic polymer; and forming the second adhesive layer on the resin layer by coating with coating a solution containing a polyphenol-based compound.

In the present disclosure, the solution containing the polyphenol-based compound may be prepared by dissolving the polyphenol-based compound in a solvent. In this case, the solvent may be deionized water (DI), a lower alcohol having 1 to 4 carbon atoms, or a mixed solvent thereof, wherein the lower alcohol having 1 to 4 carbon atoms is methanol, ethanol, n-propanol, isopropanol, n-butanol, or isobutanol.

In the present disclosure, the coating may be performed at a speed of 80 mm/min or more, 85 mm/min or more, 90 mm/min or more, 95 mm/min or more, 100 mm/min or more, 105 mm/min or more, or 110 mm/min or more, and may be performed at a speed of 180 mm/min or less, 175 mm/min or less, 170 mm/min or less, 165 mm/min or less, 160 mm/min or less, 155 mm/min or less, or 150 mm/min or less.

In the present disclosure, the coating may be dip coating, spray coating, or brush coating, but is not limited thereto and may be any coating method capable of forming a uniform layer.

In the present disclosure, the drying may be performed at 30° C. or higher, 32° C. or higher, 34° C. or higher, 36° C. or higher, 38° C. or higher, or 40° C. or higher, and may be performed at 60° C. or lower, 58° C. or lower, 56° C. or lower, 54° C. or lower, 52° C. or lower, or 50° C. or lower.

In the present disclosure, the solution containing the hydrophilic polymer may be prepared by steps of: dispersing the hydrophilic polymer in a solvent to obtain a dispersion; and heating the dispersion, thereby preparing a solution containing the hydrophilic polymer.

In the present disclosure, the solvent may be deionized water (DI), a lower alcohol having 1 to 4 carbon atoms, or a mixed solvent thereof, wherein the lower alcohol having 1 to 4 carbon atoms is methanol, ethanol, n-propanol, isopropanol, n-butanol, or isobutanol.

In the present disclosure, the heating may be performed at 100° C. or higher, 105° C. or higher, 110° C. or higher, 115° C. or higher, 120° C. or higher, 125° C. or higher, or 130° C. or higher, and may be performed at 180° C. or lower, 175° C. or lower, 170° C. or lower, 165° C. or lower, 160° C. or lower, 155° C. or lower, or 150° C. or lower, but is not limited thereto and may be performed at any temperature at which the hydrophilic polymer in the dispersion having the hydrophilic polymer dispersed therein may be completely dissolved.

In the present disclosure, the coating may be performed at a speed of 80 mm/min or more, 85 mm/min or more, 90 mm/min or more, 95 mm/min or more, 100 mm/min or more, 105 mm/min or more, or 110 mm/min or more, and may be performed at a speed of 180 mm/min or less, 175 mm/min or less, 170 mm/min or less, 165 mm/min or less, 160 mm/min or less, 155 mm/min or less, or 150 mm/min or less.

In the present disclosure, the coating may be dip coating, spray coating, or brush coating, but is not limited thereto and may be any coating method capable of forming a uniform layer.

In the present disclosure, the drying may be performed at 30° C. or higher, 32° C. or higher, 34° C. or higher, 36° C. or higher, 38° C. or higher, or 40° C. or higher, and may be performed at 60° C. or lower, 58° C. or lower, 56° C. or lower, 54° C. or lower, 52° C. or lower, or 50° C. or lower.

According to one embodiment of the present disclosure, the method may further include, after the step of forming the second adhesive layer of the composite layer, a step of repeating, once or more, steps of: forming a resin layer on the second adhesive layer by coating with a solution containing a hydrophilic polymer; and forming a second adhesive layer on the resin layer by coating with a solution containing a polyphenol-based compound. By repeating the step once or more, the composite layer may be formed in a multilayer form, thereby improving the mechanical strength of the adhesive member according to the present disclosure.

According to one embodiment of the present disclosure, the concentration ratio between the resin layer and the second adhesive layer in the composite layer may be 0.5 to 3:1, preferably 0.8 to 2.5:1, more preferably 0.8 to 2:1. When the concentration ratio is satisfied, the adhesive film and the adhesive member may exhibit excellent adhesive strength.

The method for fabricating an adhesive member including an adhesive film according to one embodiment of the present disclosure may improve the transparency and flexibility of the adhesive member without lumping and browning caused by mixing materials, by individually depositing the substrate, the adhesive layer, and the resin layer.

### Bonding Method

According to another aspect of the present disclosure, there is provided a bonding method including a step of bonding the adhesive member and a substrate together.

According to one embodiment of the present disclosure, the substrate may be a dry substrate or a wet substrate.

In the present disclosure, the dry substrate may include a metal, a polymer, or a mixture substrate thereof, and the wet substrate may be a hydrogel-type substrate.

In the present disclosure, the metal substrate may include stainless steel (SS), aluminum (Al), copper (Cu), iron (Fe), or an alloy of two or more thereof.

In the present disclosure, the polymer substrate may be a substrate made of polyimide (PI), acrylic resin, polypropylene (PP), thermoplastic polyurethane (TPU), Eco-flex, polydimethylsiloxane (PDMS), or a mixture of two or more thereof.

In the present disclosure, the hydrogel-type substrate may be a substrate including a hydrogel made of poly(vinyl alcohol, PVA), tannic acid (TA), acrylamide (AAm), N,N′-methylenebis(acrylamide, MBAA), LiCl, alginate, or a mixture of two or more thereof.

In the present disclosure, the substrate may be a substrate made of a material that is the same as or different from that of the substrate of the adhesive film.

According to one embodiment of the present disclosure, the step of bonding the dry substrate may include steps of: forming the adhesive film on the dry substrate such that the first adhesive layer of the adhesive film is adjacent to the dry substrate; bonding the dry substrate having the adhesive film formed thereon and the adhesive member together; and supplying water to the bonding interface between the dry substrate and the adhesive member, followed by heat treatment.

FIG. 6 is an image schematically showing a method of forming a bonded structure (DD bonded structure) by bonding an adhesive member and a dry substrate together according to the present disclosure.

As shown in FIG. 6, the adhesive member including the adhesive film according to the present disclosure and a dry substrate having formed therein the adhesive film according to the present disclosure are bonded together, water is supplied to the bonding interface, and polymer chains in the adhesive film are entangled by the supplied water. Thereafter, the remaining water is removed by heat treatment, and the polymer chains are aggregated, so that the adhesive member and the dry substrate may be more strongly bonded together. However, the adhesive film may be formed on the dry substrate, or the dry substrate may be directly bonded to the adhesive member having the adhesive film formed thereon without forming the adhesive film on the dry substrate.

In the present disclosure, the step of forming the adhesive film on the dry substrate may include forming the first adhesive layer on the dry substrate and forming the composite layer on the first adhesive layer. In this case, the composite layer may include a resin layer formed on the first adhesive layer, and a second adhesive layer formed on the resin layer.

In the present disclosure, in the step of forming the adhesive film on the dry substrate, the composite layer of the adhesive film may be formed to include two or more repeating units.

According to one embodiment of the present disclosure, the step of bonding the dry substrate having the adhesive film formed thereon and the adhesive member together may be performed such that the second adhesive layers of the dry substrate and the adhesive member are positioned adjacent to each other.

In the present disclosure, the supply of water may be performed by a method such as spraying or dipping, but is not limited thereto and may be performed by any method for supplying water.

In the present disclosure, the supply of water is performed to provide water into the dried adhesive film formed on each of the dry substrate and the adhesive member, thereby swelling the second adhesive layer of each of the dry substrate and the adhesive member bonded together. In this case, as the second adhesive layer swells, the mobility of the polymer chains in the adhesive film formed on each of the dry substrate and the adhesive member may be increased, leading to polymer chain entanglement. In addition, through the supply of water, polymer and water molecules may compete for hydrogen bonding sites, and thus plasticization may occur. The bonding strength between the dry substrate and the adhesive member may be increased by the polymer chain entanglement, and flexibility may be imparted through the plasticization.

In the present disclosure, the heat treatment may be performed at 70° C. or higher, 75° C. or higher, 80° C. or higher, 85° C. or higher, or 90° C. or higher, and may be performed at 160° C. or lower, 155° C. or lower, 150° C. or lower, 145° C. or lower, or 140° C. or lower.

More specifically, when the provided dry substrate is a metal substrate, the heat treatment may be performed at 80° C. or higher, 85° C. or higher, or 90° C. or higher, and may be performed at 160° C. or lower, 155° C. or lower, or 150° C. or lower.

On the other hand, when the provided dry substrate is a polymer substrate, the heat treatment may be performed at a relatively lower temperature than the metal substrate in consideration of the glass transition temperature or the like of the polymer. In this case, the heat treatment may be performed at 70° C. or higher, 75° C. or higher, or 80° C. or higher, and may be at 150° C. or lower, 145° C. or lower, or 140° C. or lower.

In the present disclosure, through the heat treatment, the supplied water may be removed, robust adhesion between the dry substrate and the adhesive member may be promoted, and the entangled polymer chains may be aggregated and fixed.

According to one embodiment of the present disclosure, the step of bonding the wet substrate may include a step of bonding the wet substrate and the adhesive member together.

In the present disclosure, when the adhesive member is bonded to the wet substrate, the second adhesive layer of the adhesive member may be formed adjacent to the wet substrate.

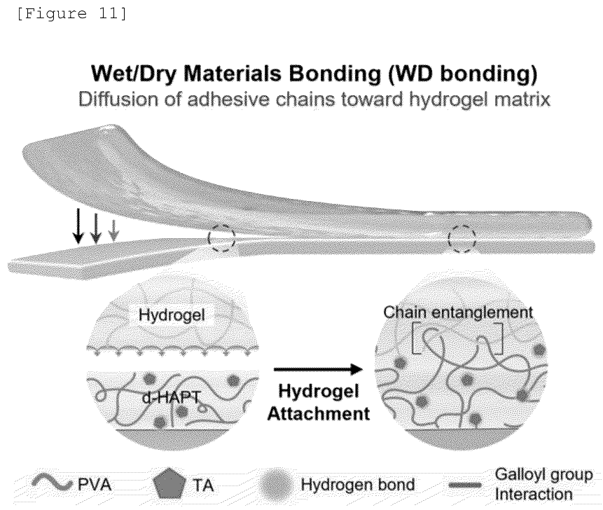

FIG. 11 is an image schematically showing a method of forming a bonded structure (WD bonded structure) by bonding an adhesive member and a wet substrate together according to the present disclosure.

As shown in FIG. 11, a wet substrate is bonded to an adhesive member having formed thereon the adhesive film (d-HAPT) according to the present disclosure. In this case, the second adhesive layer of the adhesive film is bonded so that it is adjacent to the wet substrate.

In the present disclosure, bonding of the wet substrate does not require additional water supply because water is present in the wet substrate.

In the present disclosure, as the wet substrate is bonded to the adhesive member, water in the wet substrate is absorbed into the adhesive film formed on the adhesive member, and at the same time, the polymer chains of the adhesive film diffuse into the wet substrate to form a network in the wet substrate, thereby achieving a wide range of mechanical strength and strong adhesive strength.

The bonding method using an adhesive member including an adhesive film according to one embodiment of the present disclosure enables flexible and robust bonding not only between the same materials but also between different materials.

### Soft Device

According to one aspect of the present disclosure, there is provided a soft device including the adhesive member.

In the present disclosure, the soft device may operate stably even under deformation such as stretching, bending, compression, or twisting by including the adhesive member.

In the present disclosure, the soft device may be attached to or carried on the body in the form of a wearable device such as a smartwatch or a smartband, thereby recognizing the bending and movement of the body, which may be converted into data such as position and pressure. Thus, the soft device may be applied as various sensors.

In the present disclosure, as the soft device includes an adhesive member including a biocompatible adhesive film, it may be applied in various forms, such as a skin-attachable patch, an implantable patch, artificial skin, a flexible electric stimulator, a smart contact lens, etc., not only in vitro but also in vivo.

In the present disclosure, the soft device may be used as a flexible display such as a foldable smartphone or tablet or a rollable display.

The soft device including an adhesive member according to another embodiment of the present disclosure may have excellent flexibility and biocompatibility, and thus may be applied to various fields.

In addition, the soft device according to the present disclosure may be applied to vehicle parts, including curved displays, flexible sensors, etc.

Hereinafter, the present disclosure will be described in more detail by way of preferred examples. However, these examples are intended to explain the present disclosure in more detail, and it will be apparent to those skilled in the art that the scope of the present disclosure is not limited by these examples.

As used in the following preparation examples, examples, and experimental examples, poly(vinyl alcohol) (PVA, molecular weight: 89,000 to 98,000), tannic acid (TA), acrylamide (AAm), acrylic acid (AA), N,N′-methylenebis(acrylamide) (MBAA), ammonium persulfate (APS), tetramethylethylenediamine (TEMED), and sodium alginate were purchased from Sigma Aldrich. In addition, carbon nanotubes (CNTs) were purchased from Nanolab (Korea), lithium chloride (LiCl) was purchased from Duksan (Korea), and gallium and indium were purchased from AliExpress (China). In addition, Eco-flex used as a wet substrate was purchased from Smooth-On, and poly methyl methacrylate (PMMA), polypropylene (PP), and thermoplastic polyurethane (TPU) were purchased from E&G FIL (Korea).

### Preparation Example 1. Preparation of PVA Solution

PVA (2.5% w/v) was added to deionized (DI) water and dissolved at 140° C. while stirring at a speed of 300 rpm for 2 hours, thereby preparing a PVA solution.

### Preparation Example 2. Preparation of TA Solution

TA (2.5% w/v) was dissolved in deionized water using a vortex mixer, thereby preparing a TA solution.

### Preparation Example 3. Preparation of PVA Hydrogel

PVA (4,000 mg) was added to deionized water (20 mL) and dissolved at 140° C. while stirring for 20 minutes, thereby preparing a PVA solution. The PVA solution was poured into the prepared mold and then frozen and thawed at a temperature between −20° C. and 25° C., thereby preparing a PVA hydrogel.

### Preparation Example 4. Preparation of PVA-TA Hydrogel

PVA (4,000 mg) was added to deionized water (20 mL) and dissolved at 140° C. while stirring for 20 minutes, thereby preparing a PVA solution. TA (4,000 mg) was dissolved in the PVA solution at 140° C., thereby preparing a PVA-TA solution. The PVA-TA solution was poured into the mold to a thickness of 2 mm, and then frozen and thawed at temperatures between −20° C. and 25° C., thereby preparing a PVA-TA hydrogel.

### Preparation Example 5. Preparation of PAAm-LiCl Hydrogel

A precursor solution was prepared by dissolving acrylamide monomer (AAm, 146.35 mg/ml), N,N′-methylenebis(acrylamide) (MBAA, 0.07% of AAm), ammonium persulfate (APS, 0.1% of AAm), 0.4 μL/mL of tetramethylethylenediamine (TEMED), and LiCl in deionized water. The precursor solution was poured into the mold to a thickness of 3 mm and then cured at room temperature for 4 hours, thereby preparing a PAAm-LiCl hydrogel.

### Preparation Example 6. Preparation of PAAm-Alginate Hydrogel

Alginate (29 mg/ml) was added to deionized water and dissolved by stirring at room temperature for 1 hour, thereby preparing an alginate solution. A PAAm-alginate solution was prepared by mixing the alginate solution with an AAm precursor solution containing AAm monomer (666 mg/ml), MBAA (0.06% of AAm), APS (0.75% of AA), and TEMED (2 μL/ml). The PAAm-alginate solution was poured into the mold to a thickness of 3 mm and then cured at room temperature for 4 hours, thereby preparing a PAAm-alginate hydrogel.

### Preparation Example 7. Preparation of CNT Conductive Hydrogel

20%, 30% or 40% w/v TA (Sigma-Aldrich) was first mixed with a PVA solution (20% w/v, deionized water, molecular weight: 89,000 to 98,000) which was then stirred while heating at 90° C. for 2 hours, thereby preparing TA/PVA mixed hydrogel (first mixed gel). 1% w/v fCNT was additionally added to the first mixed gel which was then stirred and heated at 90° C. for 2 hours. Then, the mixed gel was frozen at −20° C. for 8 hours and thawed at room temperature for 3 hours, thereby preparing fCNT/TA/PVA hydrogel (second mixed gel). To introduce PVA polymer chains into the second mixed gel, the second mixed gel was dried at 37° C. for 1 hour and further annealed at 100° C. for 1 hour. Then, the dried second mixed gel was immersed in an acrylic acid solution (30% w/w acrylic acid, 0.03% w/w N,N′-bis(acryloyl)cystamine, 0.15% w/w 2,2′-azobis(2-methylpropionamidine)dihydrochloride dissolved in deionized water) for 2 hours, thereby preparing CNT hydrogel.

### Example 1. Fabrication of Adhesive Member 1 Including Adhesive Film (d-HAPT)

An adhesive film including an adhesive layer and a composite layer was deposited on a substrate by a dip coating method.

More specifically, the TA solution prepared in Preparation Example 2 was applied to a glass substrate by dip coating (at a speed of 130 mm/min) and then dried at 45° C. for 10 minutes to form a first adhesive layer. Then, a first repeating unit of a composite layer was formed on the first adhesive layer. In this case, to form the first repeating unit of the composite layer, the PVA solution prepared in Preparation Example 1 was applied onto the first adhesive layer by dip coating and dried at 45° C. for 10 minutes to form a resin layer, and the TA solution prepared in Preparation Example 2 was applied onto the resin layer by dip coating and dried at 45° C. for 10 minutes to form a second adhesive layer, thereby forming the first repeating unit of the composite layer. Then, a second repeating unit of a composite layer including a resin layer and a second adhesive layer was formed on the second adhesive layer of the composite layer (first repeating unit) in the same manner, thereby fabricating adhesive member 1 (TA/PVA/TA/PVA/TA) according to the present disclosure.

### Example 2. Fabrication of Adhesive Member 2 Including Adhesive Film (d-HAPT)

Adhesive member 2 according to the present disclosure was fabricated in the same manner as in Example 1, except that a PDMS substrate was used instead of the glass substrate of Example 1.

### Example 3. Fabrication of Adhesive Member 3 Including Adhesive Film (d-HAPT)

Adhesive member 3 according to the present disclosure was fabricated in the same manner as in Example 1, except that the metal substrate shown in Table 1 below was used instead of the glass substrate of Example 1.

TABLE 1

| | Metal substrate |
|---|---|
| Adhesive member 3a | Stainless steel (SS) |
| Adhesive member 3b | Aluminum (Al) |
| Adhesive member 3c | Copper (Cu) |

### Example 4. Fabrication of Adhesive Member 4 Including Adhesive Film (d-HAPT)

Adhesive member 4 according to the present disclosure was fabricated in the same manner as in Example 1, except that the polymer substrate shown in Table 2 below was used instead of the glass substrate of Example 1.

TABLE 2

| | Polymer substrate |
|---|---|
| Adhesive member 4a | Polyimide (PI) |
| Adhesive member 4b | Polymethylmethacrylate (PMMA) |
| Adhesive member 4c | Polypropylene (PP) |
| Adhesive member 4d | Thermoplastic polyurethane (TPU) |
| Adhesive member 4e | Eco-flex |

### Example 5. Adhesive Member-Dry Substrate Bonded Structure 1 (DD Bonded Structure 1)

First, a polydimethylsiloxane (PDMS) polymer substrate was used as a dry substrate. An adhesive film including a first adhesive layer and a composite layer composed of a first repeating unit and a second repeating unit was formed on the dry substrate in the same manner as in Example 1. Then, the dry substrate having the adhesive film formed thereon and adhesive member 2 fabricated in Example 2 were bonded together. At this time, the dry substrate and the adhesive member were bonded together so that their respective second adhesive layers were positioned adjacent to each other. Next, water was supplied to the bonding interface between the dry substrate and the adhesive member by spraying to induce polymer chain entanglement at the bonding interface for 1 minute, thereby bonding them together. Then, the bonded dry substrate and adhesive member were heat-treated at 130° C. for 60 seconds, thereby forming DD bonded structure 1 according to the present disclosure.

### Example 6. Adhesive Member-Dry Substrate Bonded Structure 2 (DD Bonded Structure 2)

First, stainless steel (SS), aluminum (Al), and copper (Cu) metal substrates were used as dry substrates, respectively. An adhesive film including a first adhesive layer and a composite layer composed of a first repeating unit and a second repeating unit was formed on each of the dry substrates in the same manner as in Example 1. Then, each of the dry substrates having the adhesive film formed thereon and each of adhesive members 3a to 3c fabricated in Example 3 were bonded together using the combinations shown in Table 3 below. At this time, the dry substrate and the adhesive member were bonded together so that their respective second adhesive layers were positioned adjacent to each other. Next, water was supplied to the bonding interface between the dry substrate and the adhesive member by spraying to induce polymer chain entanglement at the bonding interface, thereby bonding them together. Then, the bonded dry substrate and adhesive member were heat-treated at 130° C. for 60 seconds, thereby forming DD bonded structures 2a to 2c according to the present disclosure.

TABLE 3

| | Adhesive member | Dry substrate |
|---|---|---|
| Adhesive member-dry substrate | Adhesive member | Stainless steel |
| bonded structure 2a (DD bonded | 3a | (SS) |
| structure 2a) | | |
| Adhesive member-dry substrate | Adhesive member | Aluminum (Al) |
| bonded structure 2b (DD bonded | 3b | |
| structure 2b) | | |
| Adhesive member-dry substrate | Adhesive member | Copper (Cu) |
| bonded structure 2c (DD bonded | 3c | |
| structure 2c) | | |

### Example 7. Adhesive Member-Dry Substrate Bonded Structure 3 (DD Bonded Structure 3)

First, polyimide (PI), acrylic, and polypropylene (PP) polymer substrates were used as dry substrates, respectively. An adhesive film including a first adhesive layer and a composite layer composed of a first repeating unit and a second repeating unit was formed on each of the dry substrates in the same manner as in Example 1. Then, each of the dry substrates having the adhesive film formed thereon and each of adhesive members 4a to 4c fabricated in Example 4 were bonded together using the combinations shown in Table 4 below. At this time, the dry substrate and the adhesive member were bonded together so that their respective second adhesive layers were positioned adjacent to each other. Next, water was supplied to the bonding interface between the dry substrate and the adhesive member by spraying to induce polymer chain entanglement at the bonding interface, thereby bonding them together. Then, the bonded dry substrate and adhesive member were heat-treated at 100° C. for 60 seconds, thereby forming DD bonded structures 3a to 3c according to the present disclosure.

TABLE 4

| | Adhesive member | Dry substrate |
|---|---|---|
| Adhesive member-dry substrate | Adhesive member 4a | Polyimide (PI) |
| bonded structure 3a (DD bonded | | |
| structure 3a) | | |
| Adhesive member-dry substrate | Adhesive member 4b | Acrylic |
| bonded structure 3b (DD bonded | | |
| structure 3b) | | |
| Adhesive member-dry substrate | Adhesive member 4c | Polypropylene |
| bonded structure 3c (DD bonded | | (PP) |
| structure 3c) | | |

### Example 8. Adhesive Member-Dry Substrate Bonded Structure 4 (DD Bonded Structure 4)

First, the PDMS or polymer substrate shown in Table 5 below was used as a dry substrate. An adhesive film including a first adhesive layer and a composite layer composed of a first repeating unit and a second repeating unit was formed on each of the dry substrates in the same manner as in Example 1. Then, each of the dry substrates having the adhesive film formed thereon and each of the adhesive members fabricated in Examples 3 and 4 were bonded together using the combinations shown in Table 5 below. At this time, the dry substrate and the adhesive member were bonded together so that their respective second adhesive layers were positioned adjacent to each other. Next, water was supplied to the bonding interface between the dry substrate and the adhesive member by spraying to induce polymer chain entanglement at the bonding interface, thereby bonding them together. Then, the bonded dry substrate and adhesive member were heat-treated at 100° C. for 60 seconds, thereby forming DD bonded structures 4a to 4h according to the present disclosure.

TABLE 5

| | | Dry |
|---|---|---|
| | Adhesive member | substrate |
| Adhesive member-dry substrate | Adhesive member | Polyimide (PI) |
| bonded structure 4a (DD bonded | 3a | |
| structure 4a, SS/PI) | | |
| Adhesive member-dry substrate | Adhesive member | PI |
| bonded structure 4b (DD bonded | 4d | |
| structure 4b, TPU/PI) | | |
| Adhesive member-dry substrate | Adhesive member | Polydimethyl- |
| bonded structure 4c (DD bonded | 3a | siloxane |
| structure 4c, SS/PDMS) | | (PDMS) |
| Adhesive member-dry substrate | Adhesive member | PDMS |
| bonded structure 4d (DD bonded | 4d | |
| structure 4d, TPU/PDMS) | | |
| Adhesive member-dry substrate | Adhesive member | Eco-flex |
| bonded structure 4e (DD bonded | 4d | |
| structure 4e, TPU/Eco-flex) | | |
| Adhesive member-dry substrate | Adhesive member | PDMS |
| bonded structure 4f (DD bonded | 4a | |
| structure 4f, PI/PDMS) | | |
| Adhesive member-dry substrate | Adhesive member | Eco-flex |
| bonded structure 4g (DD bonded | 4a | |
| structure 4g, PI/Eco-flex) | | |
| Adhesive member-dry substrate | Adhesive member | Eco-flex |
| bonded structure 4h (DD bonded | 2 | |
| structure 4h, PDMS/Eco-flex) | | |

### Example 9. Adhesive e Member-Wet Substrate Bonded Structure 1 (WD Bonded Structure 1)

First, the PAAm-alginate hydrogel substrate prepared in Preparation Example 6 was used as a wet substrate. The wet substrate and adhesive member 4e (Eco-flex substrate) fabricated in Example 4 were bonded together. At this time, the wet substrate and adhesive member 4e were bonded together such that the wet substrate was positioned adjacent to the second adhesive layer of adhesive member 4e, thereby forming WD bonded structure 1 according to the present disclosure.

TABLE 6

| | Adhesive member | Wet substrate |
|---|---|---|
| Adhesive member-wet | Adhesive member | PAAm-alginate hydrogel |
| substrate bonded structure | 4e | (Preparation Example |
| 1 (WD bonded structure) | | 6) |

### Example 10. Adhesive Member-Wet Substrate Bonded Structure 2 (WD Bonded Structure 2)

First, the PVA-TA hydrogel substrate prepared in Preparation Example 4 was used as a wet substrate. The wet substrate and each of the adhesive members fabricated in Examples 1, 3, and 4 were bonded together using the combinations shown in Table 7 below to form WD bonded structures 2a to 2c according to the present disclosure.

TABLE 7

| | Adhesive member | Wet substrate |
|---|---|---|
| Adhesive member-wet | Adhesive member 1 | PVA-TA hydrogel |
| substrate bonded | | (Preparation Example |
| structure 2a (WD bonded | | 4) |
| structure 2a) | | |
| Adhesive member-wet | Adhesive member 4a | PVA-TA hydrogel |
| substrate bonded | | (Preparation Example |
| structure 2b (WD bonded | | 4) |
| structure 2b) | | |
| Adhesive member-wet | Adhesive member 3a | PVA-TA hydrogel |
| substrate bonded | | (Preparation Example |
| structure 2c (WD bonded | | 4) |
| structure 2c) | | |

### Example 11. Adhesive Member-Wet Substrate Bonded Structure 3 (WD Bonded Structure 3)

First, the PVA hydrogel substrate prepared in Preparation Example 3 was used as a wet substrate. The wet substrate and each of the adhesive members fabricated in Examples 1, 3, and 4 were bonded together using the combinations shown in Table 8 below to form WD bonded structures 3a to 3c according to the present disclosure.

TABLE 8

| | Adhesive member | Wet substrate |
|---|---|---|
| Adhesive member-wet | Adhesive member 1 | PVA hydrogel |
| substrate bonded structure | | (Preparation |
| 3a (WD bonded structure 3a) | | Example 3) |
| Adhesive member-wet | Adhesive member 4a | PVA hydrogel |
| substrate bonded structure | | (Preparation |
| 3b (WD bonded structure 3b) | | Example 3) |
| Adhesive member-wet | Adhesive member 3a | PVA hydrogel |
| substrate bonded structure | | (Preparation |
| 3c (WD bonded structure 3c) | | Example 3) |

### Example 12. Adhesive Member-Wet Substrate Bonded Structure 4 (WD Bonded Structure 4)

First, the PAAm-alginate hydrogel substrate prepared in Preparation Example 6 was used as a wet substrate. The wet substrate and each of the adhesive members fabricated in Examples 1, 3, and 4 were bonded together using the combinations shown in Table 9 below to form WD bonded structures 4a to 4c according to the present disclosure.

TABLE 9

| | Adhesive | |
|---|---|---|
| | member | Wet substrate |
| Adhesive member-wet | Adhesive | PAAm-alginate |
| substrate bonded structure | member 1 | hydrogel (Preparation |
| 4a (WD bonded structure 4a) | | Example 6) |
| Adhesive member-wet | Adhesive | PAAm-alginate |
| substrate bonded structure | member 4a | hydrogel (Preparation |
| 4b (WD bonded structure 4b) | | Example 6) |
| Adhesive member-wet | Adhesive | PAAm-alginate |
| substrate bonded structure | member 3a | hydrogel (Preparation |
| 4c (WD bonded structure 4c) | | Example 6) |

### Experimental Example 1. Hydrogen Bond Formation in Adhesive Member

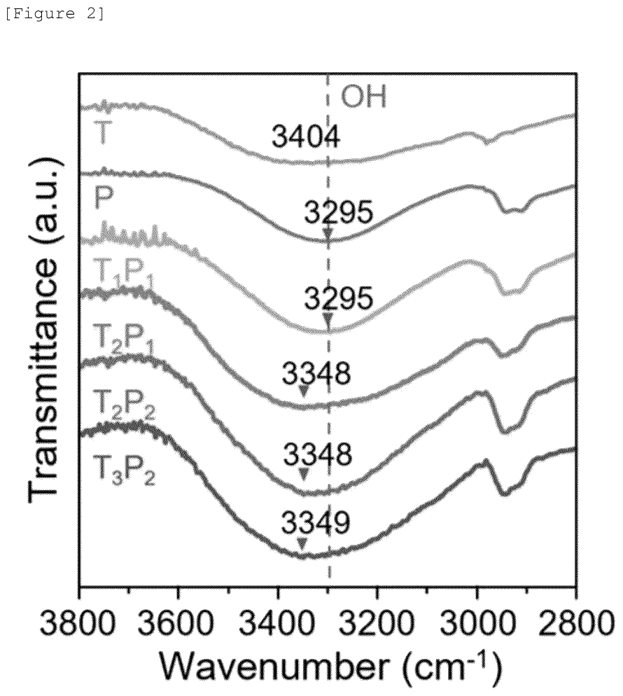

In order to confirm that strong hydrogen bonds were formed between the adhesive layer (TA layer) and the resin layer (PVA layer) in the adhesive film according to the present disclosure and the adhesive member including the same, ATR-FTIR spectroscopy ((ATR-FTIR spectroscopy, Vertex 70, Bruker, USA) analysis was performed in the wavelength range of 2,800 cm⁻¹ to 3,800 cm⁻¹ on each layer of the adhesive member including the adhesive film (d-HAPT), fabricated in Example 1, and the results are shown in FIG. 2.

As shown in FIG. 2, the first adhesive layer (T) formed on the glass substrate showed a broad and dull peak at 3,100 to 3,500 cm⁻¹, indicating a hydroxyl group (—OH) stretching band. The resin layer (T₁P₁) in the composite layer (first repeating unit) formed on the first adhesive layer showed methylene group (—CH₂—) stretching peaks at 2,908 cm⁻¹ and 2,941 cm⁻¹, which are characteristic of PVA, along with the OH stretching band. This result shows that the resin layer was successfully deposited after the first adhesive layer formed on the substrate. Moreover, as the adhesive layer and the resin layer were successively stacked (T₂P₁, T₂P₂ and T₃P₂), the OH-stretching peak gradually shifted to higher wavenumbers, from 3,295 cm⁻¹ for pure P to 3,349 cm⁻¹ for the T₃P₂. The obvious blue shift of the peak suggests the enhancement of strong hydrogen bonding between the adhesive layer (TA) and the resin layer (PVA).

### Experimental Example 2. Surface Coating Uniformity

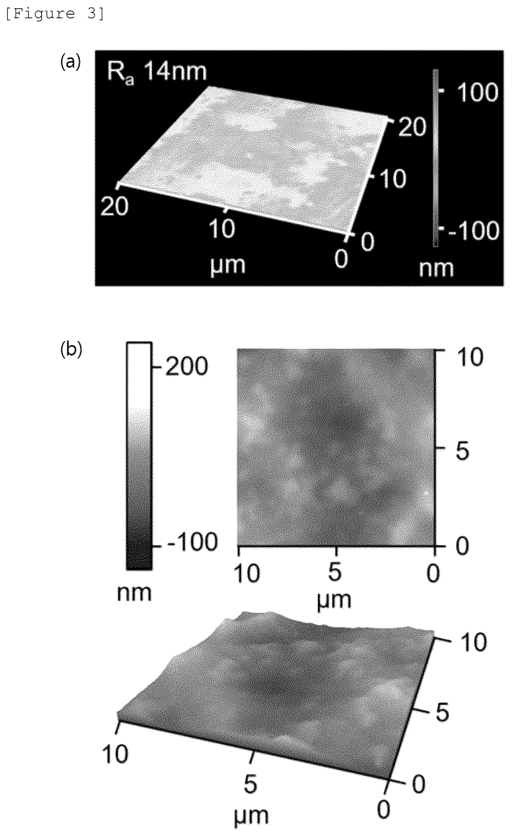

In order to confirm that each layer was uniformly deposited in the stacked structure of the adhesive film and the adhesive member including the same according to the present disclosure, (a) laser confocal microscope (VK-X3050, Keyenece) and (b) atomic force microscope (AFM, NX-10, Park Systems) images were measured for the adhesive member including the adhesive film (d-HAPT), fabricated in Example 1, and the results are shown in FIG. 3.

As shown in FIG. 3, it can be confirmed that the adhesive film obtained by coating and deposition according to the present disclosure has excellent deposition uniformity.

### Experimental Example 3. Mechanical Stability (Durability)

Because the adhesive film according to the present disclosure should establish a robust bonding at the interface between the two materials constituting the adhesive layer and the resin layer so as to remain securely affixed to the substrate even under the influence of an external force, the mechanical stability (durability) thereof was examined.

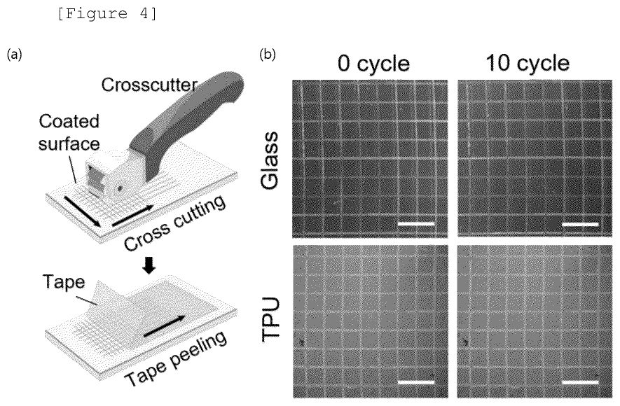

First, as shown in FIG. 4(a), a cross-cut adhesion test (ISO 2409) was performed in which the surfaces of the glass substrate including the adhesive film (d-HAPT) fabricated in Example 1 (adhesive member 1) according to the present disclosure and the TPU substrate including the adhesive film (d-HAPT) fabricated in Example 4 (adhesive member 4d) were scratched using a crosscutter, and then the adhesive films on the surfaces of the glass substrate and the TPU substrate were removed. This process was repeated 10 times. At this time, the optical images of the glass substrate and TPU substrate were measured, and the results are shown in FIG. 4.

As shown in FIG. 4, after the cross-cut adhesion test, the adhesive film attached to each of the glass substrate and the TPU substrate was stably maintained on both the glass substrate and the TPU substrate.

### Experimental Example 4. Transparency of Adhesive Film

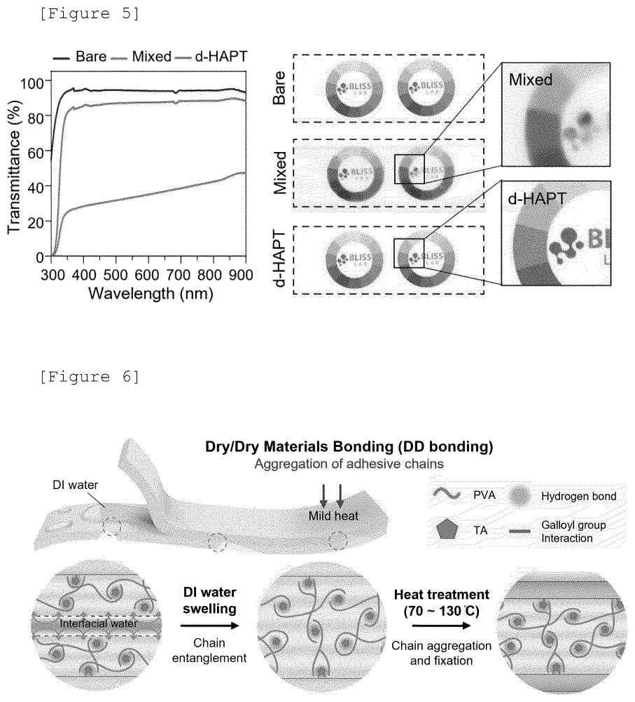

The adhesive film (d-HAPT) according to the present disclosure must maintain excellent transparency in order to be applied to various soft electronic devices. To confirm this, the transmittance was measured using a UV-Vis spectrophotometer (V-650, JASCO) in the wavelength range of 300 to 900 nm for the glass substrate coated with the adhesive film (d-HAPT) manufactured in Example 1 according to the present disclosure (red line, d-HAPT, adhesive member 1), the glass substrate coated with the PVA/TA mixed solution prepared in Preparation Example 4 (green line, Mixed), and a bare glass substrate (black line, Bare), and the results are shown in FIG. 5.

As shown in FIG. 5, the glass substrate (red line, adhesive member 1) coated with the adhesive film (d-HAPT) fabricated in Example 1 according to the present disclosure exhibited a high transmittance of about 85%, which is almost similar to that of the bare glass substrate (black line, Bare), across the entire visible light spectrum (400 to 750 nm). This high transmittance suggests once again that each layer constituting the adhesive film according to the present disclosure was uniformly deposited, as confirmed in Experimental Example 2. In contrast, the transmittance of the glass substrate coated with the PVA/TA mixed solution (green line, Mixed) dropped dramatically to less than about 40%, which can be seen with the naked eye through the optical images. This is because in the case of coating with a mixed solution of TA, which constitutes the adhesive layer, and PVA, which constitutes the resin layer, opacity is caused by the formation of yellowish precipitates due to the strong hydrogen bonding between PVA chains and TA molecules.

From the above results, it can be seen that the adhesive film according to the present disclosure may be fabricated as a uniform adhesive film having high transparency due to the controlled formation of hydrogen bonds at the interface of the adhesive layer and the resin layer and minimal diffuse reflection, by sequentially depositing the components constituting the adhesive layer and the resin layer on a substrate without mixing them, suggesting that such an adhesive film has the potential to provide reliable alignment of chips and electrodes in various soft electronic devices.

### Experimental Example 5. Characterization of Adhesive Member-Dry Substrate Bonded Structure (DD Bonded Structure)

### 5.1. Transparency, Flexibility and Bonding Uniformity

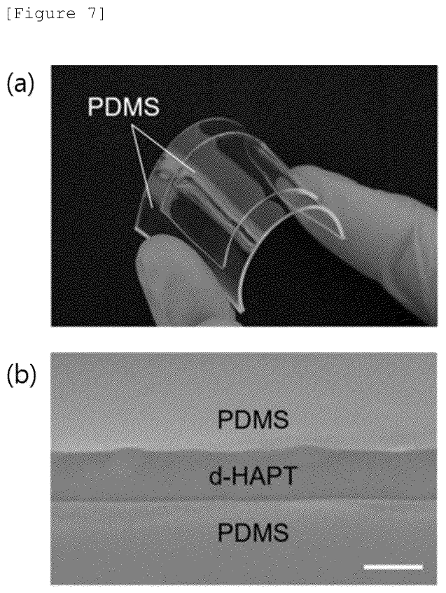

In order to examine the transparency, flexibility and bonding uniformity of the bonded structure formed by bonding a dry substrate to the adhesive member including the adhesive film (d-HAPT) according to the present disclosure, an optical image was taken of DD bonded structure 1 formed in Example 5, and a cross-section of the DD bonded structure was measured using a scanning electron microscope (FE-SEM, IT-500 HR, JEOL). The results are shown in FIG. 7.

As shown in FIG. 7(a), it can be confirmed that the DD bonded structure formed by bonding the dry substrate with the adhesive member including the adhesive film (d-HAPT) according to Example 5 of the present disclosure has transparent and flexible properties. In addition, as shown in FIG. 7(b), it can be confirmed through the cross-sectional image of the DD bonded structure that no defects or boundaries are visible between the adhesive member including the adhesive film and the dry substrate and that they were bonded together densely and uniformly.

### 5.2. Bonding Strength of Bonded Structure Formed by Bonding Identical Metal Dry Substrates

In order to examine the bonding strength of the bonded structure formed by bonding a dry substrate to the adhesive member including the adhesive film according to the present disclosure, lap shear tests were conducted.

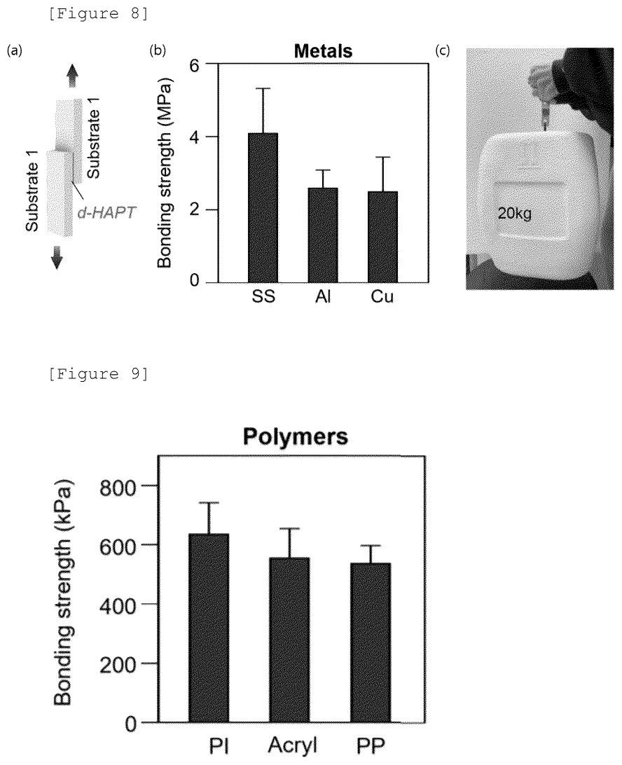

As shown in FIG. 8(a), DD bonded structures 2a to 2c formed in Example 6 were prepared into samples having a bonding area of 15×20 mm, and the bonding strength was measured with a tensile tester (Multitest-dV, Mecmesin) using a 2,500 N load cell at a constant peeling speed of 5 mm/min, and the results are shown in FIG. 8.

As shown in FIG. 8(b), the bonding strengths of DD bonded structures 2a to 2c formed by bonding the adhesive member including the adhesive film (d-HAPT) to the dry substrate made of the same metal material as that of the dry substrate of the adhesive member in Example 6 exceeded 4.1±1.2 MPa, 2.6±0.5 MPa, and 2.5±0.9 MPa, respectively. In particular, as shown in FIG. 8(c), the bonding strength of DD bonded structure 2a formed using stainless steel (SS) as a substrate showed the highest bonding strength of 4 MPa or more, and exhibited a strong adhesion enough to support a 20 kg water tank.

These values are 50 times higher than the bonding strength observed in other conventional hydrogel-based adhesive members capable of attaching metals with a strength of up to 80 kPa. This excellent bonding strength can be attributed to the galloyl interactions (coordination bonds) on the metal substrate and the hydrogen bonding at the interface between the adhesive layer and the resin layer.

### 5.3. Bonding Strength of Bonded Structure Formed by Bonding Identical Polymer Dry Substrates

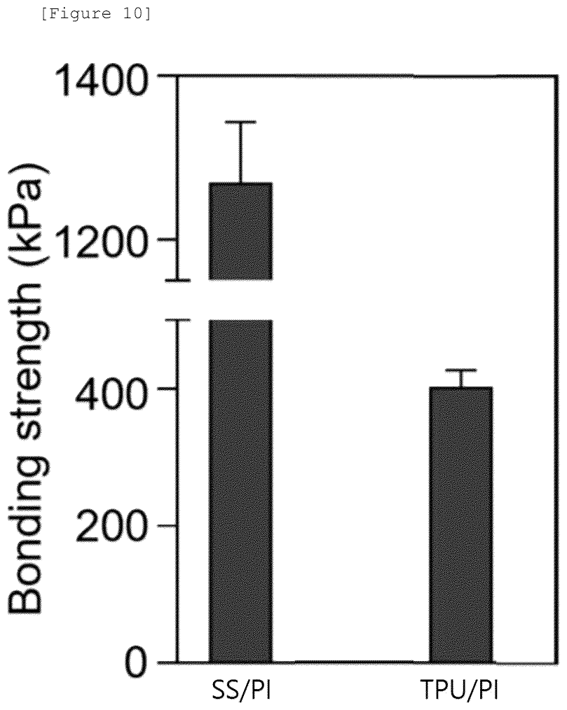

In order to examine the bonding strength of the bonded structure formed by bonding a dry substrate with the adhesive member including the adhesive film (d-HAPT) according to the present disclosure, lap shear tests were conducted on DD bonded structures 3a to 3c formed in Example 7 in the same manner as in Experimental Example 5.2, and the results are shown in FIG. 9.

As shown in FIG. 9, the bonding strengths of DD bonded structures 3a to 3c formed by bonding the adhesive member including the adhesive film (d-HAPT) to the dry substrate made of the same metal material as that of the dry substrate of the adhesive member in Example 7 were 637.6±105 kPa, 556.7±98 kPa, and 537.911±60 kPa, respectively, indicating that the bonding strengths of all the bonded structures exceeded 500 kPa.

It can be seen that these values are significantly higher than the bonding strengths observed in other conventional hydrogel-based adhesive members capable of attaching metals with a strength of up to 80 kPa.

### 5.4. Bonding Strength of Bonded Structure Formed by Bonding Different Dry Substrates

For practical applications, adhesive compatibility between substrates of different materials is very crucial due to the disparities in mechanical and chemical properties between the materials. Thus, lap shear tests were conducted on DD bonded structures 4a and 4b, formed by bonding substrates of different materials in Example 8, in the same manner as in Experimental Example 5.2. The results are shown in FIG. 10.

As shown in FIG. 10, DD bonded structure 4a (SS/PI), fabricated by bonding metal-polymer dry substrates in Example 8, and DD bonded structure 4b (TPU/PI), fabricated by bonding polymer-polymer dry substrates in Example 8, had excellent bonding strength. In particular, DD bonded structure 4a (SS/PI), fabricated by bonding metal-polymer dry substrates, had a bonding strength exceeding 1,200 kPa, suggesting that it can be applied to various soft devices.

### Experimental Example 6. Characterization of Adhesive Member-Wet Substrate Bonded Structure (WD Bonded Structure)

### 6.1. Mechanical Robustness of WD Bonded Structure

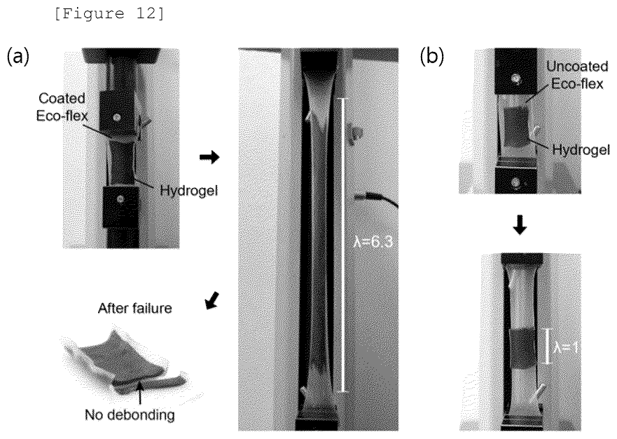

In order to demonstrate the mechanical robustness of the bonded structure formed by bonding a wet substrate to the adhesive member including the adhesive film (d-HAPT) according to the present disclosure, tensile stress was measured for WD bonded structure 1 formed in Example 9 and PAAm-alginate hydrogel (Preparation Example 6) bonded to a substrate (polymer substrate, Eco-flex) on which the adhesive film according to the present disclosure was not formed. The results are shown in FIG. 12.

As shown in FIG. 12(a), it can be confirmed that WD bonded structure 1 formed by bonding a wet substrate to the adhesive member including the adhesive film (d-HAPT) according to the present disclosure exhibited excellent mechanical robustness through its remarkable stretchability. At this time, WD bonded structure 1 endured strains over 600% of its original length without delamination between the substrates. On the other hand, (b) it can be confirmed that the PAAm-alginate hydrogel (Preparation Example 6) bonded to the substrate without the adhesive film according to the present disclosure was easily delaminated from the substrate.

### 6.2. Bonding Strength of WD Bonded Structure

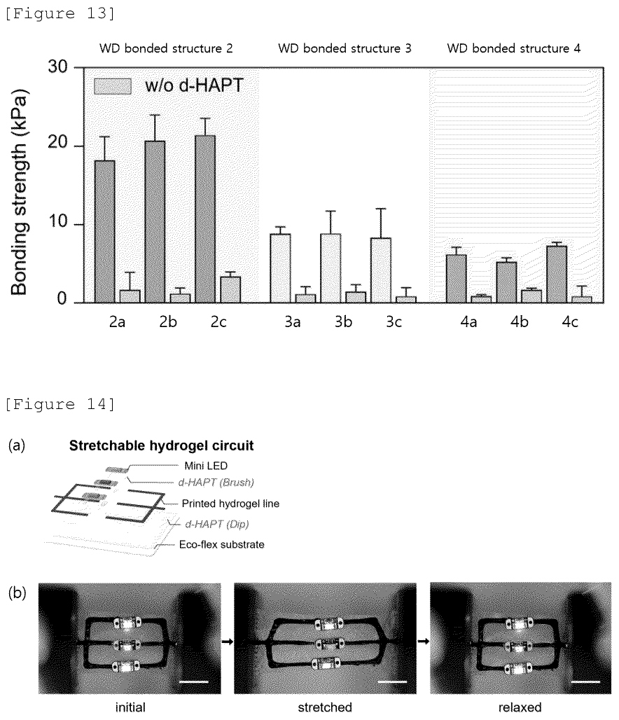

In order to examine the bonding strength of the bonded structure formed by bonding a wet substrate to the adhesive member including the adhesive film (d-HAPT) according to the present disclosure, lap shear tests were performed in the same manner as in Experimental Example 5.2 using nine WD bonded structures (WD bonded structures 2 to 4) formed in Examples 10 to 12 of the present disclosure and nine comparative WD bonded structures formed by bonding a wet substrate to a substrate not including the adhesive film (d-HAPT). The results are shown in FIG. 13.

As shown in FIG. 13, it can be confirmed that the nine WD bonded structures formed in Examples 10 to 12 according to the present disclosure had significantly superior bonding strengths compared to the nine comparative WD bonded structures formed by bonding the wet substrate to the substrate not including the adhesive film (d-HAPT). In particular, it can be expected that WD bonded structures 2a to 2c formed in Example 10 exhibit stronger bonding strength as the PVA-TA hydrogel, which is a tough hydrogel, quickly supplies moisture into the resin layer on the adhesive member.

From the above results, it can be seen that the adhesive member including the adhesive film (d-HAPT) according to the present disclosure is more strongly and robustly bonded to the wet substrate.

### 6.3. Applicability of Adhesive Member to Electronic Devices

To demonstrate the applicability of a bonded structure, formed by bonding a wet substrate to the adhesive member including the adhesive film (d-HAPT) according to the present disclosure to electronic devices, a simple stretchable circuit system was fabricated using a WD bonded structure formed by bonding a conductive CNT hydrogel wet substrate.

As shown in FIG. 14(a), to fabricate the stretchable circuit system, the adhesive film was formed on each of the Eco-flex polymer substrate and the electrodes of the LED chip (Adafruit LED, Adafruit) as in Example 1. Then, the CNT hydrogel was printed on the Eco-flex polymer substrate having the adhesive film formed thereon using a 3D printer (EZROBO-5GX 3D printer, Iwashita) equipped with a dispenser (AD3300C dispenser, Iwashita). Then, the adhesive film formed on one side of the LED chip was placed on the CNT hydrogel. A DC power supply (DP832, Rigol) was used to turn on the LED chip. At this time, the CNT hydrogel served as an interconnector. The result is shown in FIG. 14(b).

As shown in FIG. 14(b), the fabricated stretchable circuit system (device) exhibited excellent stretchability without delamination of the LED chip. When a voltage was applied to both ends, the light of the LED was turned on. Also, the light of the LED was maintained even when the flexible circuit system was stretched to 150% of its initial length. Moreover, the reduced LED light intensity was restored as soon as the stretchable circuit system returned to its original length, suggesting that the stable adhesion of the soft and rigid components via the adhesive film was achieved between the substrate in the adhesive member including the adhesive film (d-HAPT) according to the present disclosure and the hydrogel.

### Experimental Example 7. Application to Wearable Touch Panel

It was confirmed that the adhesive member including the adhesive film (d-HAPT) according to the present disclosure was applicable to a wearable electronic device.

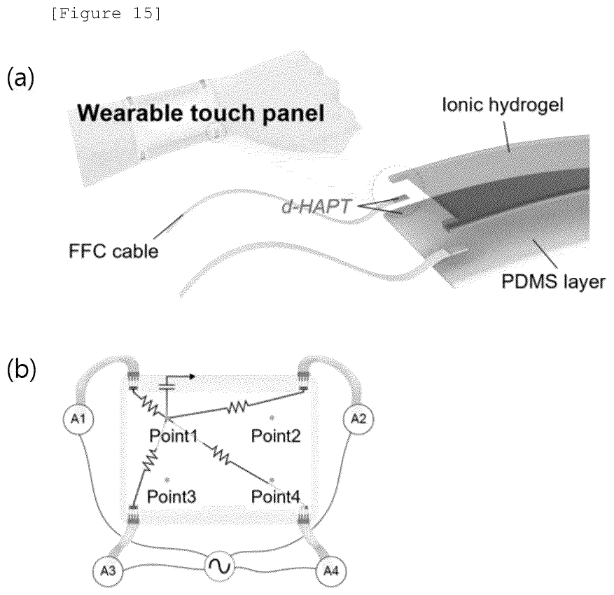

As shown in FIG. 15(a), a wearable touch panel was fabricated, which consists of three layers: a 3 mm thick ionic hydrogel for touch detection (Preparation Example 5, PAAm-LiCl hydrogel), flexible flat cables (FFCs) for signal transmission to four vortexes (edges) of the ionic hydrogel, and adhesive member 2 (Example 2) according to the present disclosure that acts as an insulator. At this time, the flexible flat cables (FFCs) of the wearable touch panel were connected to a device that analyzes the current change caused by touching the touch panel. To measure the degree of changes in current from touch, an AC voltage of 100 kHz from −1 V to 1 V was applied to the four vertexes using a function generator (AFG1022, Tektronix). The current at each vertex was measured through a multimeter (34461A, Keysight). In addition, to confirm the operation of the wearable touch panel, FFCs attached to the touch panel were connected to a controller board (EXII-7720SC, 3M Touch Systems). Software MT7 (3M, MicroTouch) was used as a calibration tool for the wearable touch panel. The operating principle of the wearable touch panel is based on the surface capacitance method as shown in FIG. 15(b).

### 7.1. Whether Wearable Touch Panel Operates

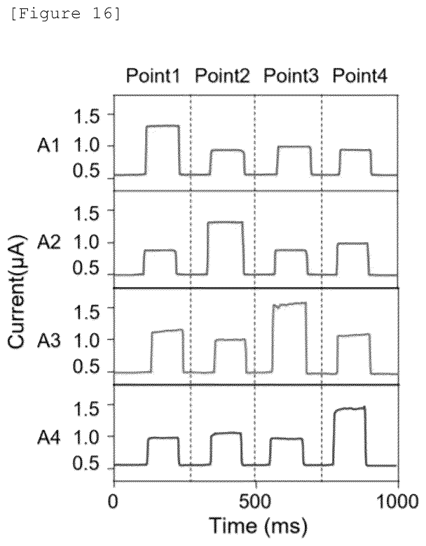

It was checked whether the fabricated wearable touch panel operated. After applying the wearable touch panel to the wrist, the change in current when touching the touch panel with a finger was measured. The results are shown in FIG. 16.

As shown in FIG. 16, a visible difference in the current was observed when the finger touched. In particular, it can be confirmed that the current upon the touch of the finger was proportional to touch point proximity to the corner electrodes.

### 7.2. Applications Via Wearable Touch Panel

Current data confirmed in the wearable touch panel fabricated by applying the adhesive film according to the present disclosure were converted into position data to confirm whether the reflection of the touch on the monitor was possible.

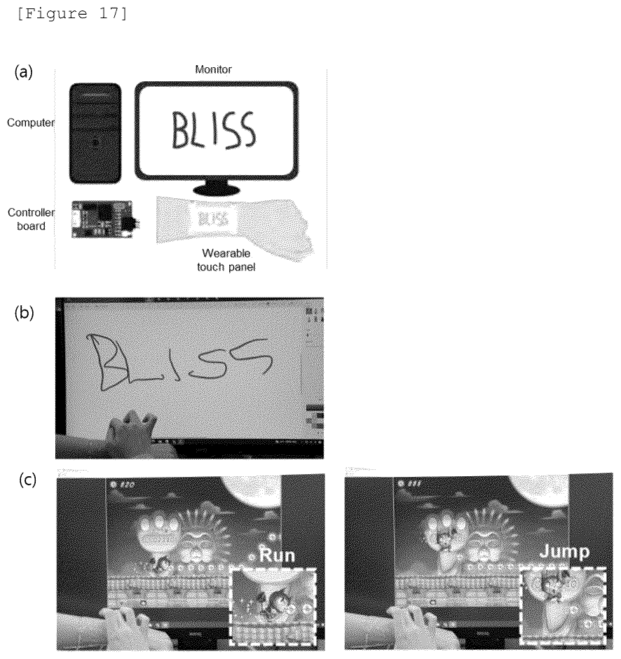

As shown in FIG. 17(a), a controller board was used to convert the current data of the wearable touch panel into the position on the wearable touch panel. This wearable touch panel was attached to the forearm seamlessly and then interfaced with a computer system through the controller board. The word “BLISS” was written on the wearable touch panel, and the wearable touch panel was mounted. A video game, avoiding obstacles by jumping, was performed using the wearable touch panel. The results are shown in FIG. 17.

As shown in FIG. 17(b), it can be confirmed that the wearable touch panel to which the adhesive member including the adhesive film (d-HAPT) according to the present disclosure has been applied could successfully recognize high-resolution letters. In addition, as shown in FIG. 17(c), it can be confirmed that tactile interaction with the video wearable touch panel applied induced the character jumps. From the above results, it can be seen that the wearable touch panel integrated through the adhesive member including the adhesive film according to the present disclosure successfully operated on the human body.

### Experimental Example 8. Application to Wearable Sensor

Wearable strain sensors (hydrogel strain sensors) are promising bioelectronic applications that can monitor various human body movements, but their practical utility has been hampered by unstable adhesion and connection between integrating components, such as a substrate, a cable, and a sensing layer. In addition, this difficulty causes problems in maintaining its shapes and securing consistent data acquisition during vigorous physical motion. In response to this difficulty, a wearable strain sensor was fabricated using the adhesive member including the adhesive film according to the present disclosure.

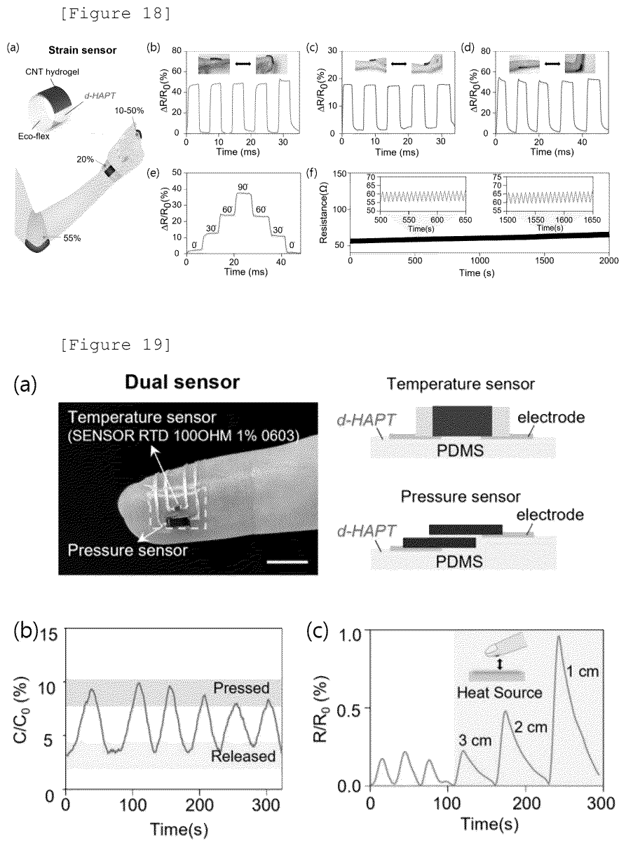

As shown in FIG. 18(a), adhesive member 4e (Eco-flex) including the adhesive film (d-HAPT), fabricated in Example 4 according to the present disclosure, was used as a substrate that can be applied to body parts such as a finger, a wrist, and an elbow. The CNT conductive hydrogel was placed on adhesive material 4e and the changes in resistance was measured by bending the joint. At this time, for measurement, the CNT hydrogel was connected to a multimeter using a coated conductive thread (conductive stainless steel thread, DFRobot), and changes in resistance and capacitance were also measured with the multimeter. In addition, liquid metal (75% gallium and 25% indium) was screen-printed on adhesive member 4e (Eco-flex), and a thermistor and a pressure sensor were integrated, thereby fabricating a wearable sensor.

### 8.1. Whether Wearable Sensor Operates

It was checked whether the fabricated wearable sensor operated. The wearable sensor was applied to various joints such as a finger, wrist, and elbow, and then it was checked whether the wearable sensor operated even during the bending of the joints. The results are shown in FIGS. 18(b) to 18(d).

As shown in FIG. 18, it can be confirmed that the measurement of electrical resistance was smoothly achieved without any damage to the interface between the hydrogel and adhesive member 4e (Eco-flex) substrate of the wearable sensor even during the bending of the joints, including a finger (b), a wrist (c), and an elbow (d). Also, although the resistance modulation was influenced by the range of motion within the joints, such as a finger, a wrist and an elbow, a resistance alteration rate across all cases exceeded 20%.

### 8.2. Angle Sensing Capability and Durability of Wearable Sensor

Considering the excellent sensitivity of the wearable sensor, precise angle-dependent sensing performance was evaluated on the finger, and the results are shown in FIG. 18(e).

As shown in FIG. 18(e), it can be confirmed that the resistance value of the wearable sensor changes constantly depending on the finger bending angle, suggesting that the wearable sensor can sense a precise angle.

In addition, the durability of the wearable sensor to which the adhesive member including the adhesive film according to the present disclosure has been applied was evaluated by systematically performing extensive stretching cycles of the wearable sensor, and the results are shown in FIG. 18(f).

As shown in FIG. 18(f), it can be confirmed that the wearable sensor to which the adhesive member including the adhesive film (d-HAPT) according to Example 4 of the present disclosure has been applied consistently exhibited stable and reliable sensing characteristics throughout 300 stretching cycles. The above result can demonstrate the robustness and durability of the wearable sensor to which the adhesive member including the adhesive film (d-HAPT) according to the present disclosure has been applied.

### Experimental Example 9. Application to Wearable Dual Sensor

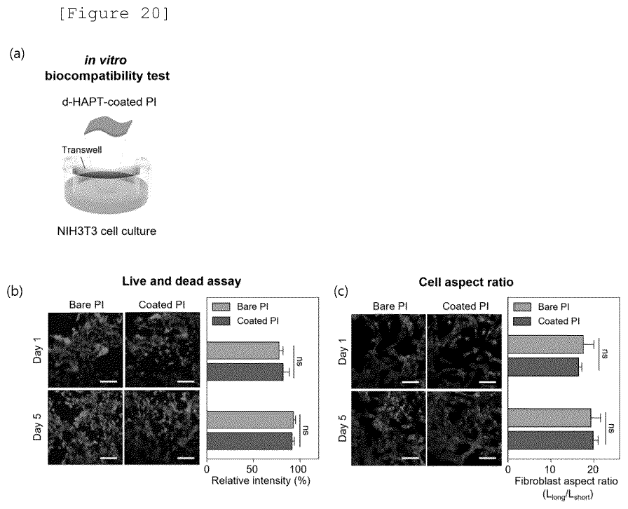

To confirm that the adhesive member including the adhesive film (d-HAPT) according to the present disclosure is applicable to a wearable dual sensor, a wearable dual sensor was fabricated and attached to a fingertip as shown in FIG. 19(a). At this time, the adhesive member used was adhesive member 2 fabricated in Example 2, and the PAAm-LiCl hydrogel prepared in Preparation Example 6 was applied as the wet substrate. Then, the finger to which the wearable dual sensor has been attached was exposed to a heat source, and the temperature sensitive properties depending on the distance from the heat source and the capacitance properties depending on the pressure were measured. The results are shown in FIGS. 19(b) and 19(c).

As shown in FIG. 19(b), it was observed that the resistance increased as the distance between the finger to which the wearable dual sensor has been attached and the heat source got close from 3 cm to 1 cm, which indicates temperature-sensitive properties. In addition, as shown in FIG. 19(c), it can be confirmed that, in the case of the pressure sensor, the capacitance increases when the wearable dual sensor came into contact with various objects.

The above results demonstrate that the adhesive member including the adhesive film according to the present disclosure can be stably integrated with soft materials such as a wearable dual sensor, suggesting that it has the potential to be applied to a wearable biosensor.

### Experimental Example 10. Biocompatibility of Adhesive Member Including Adhesive Film (d-HAPT)

Soft electronic devices have attracted attention as a solution to mechanical challenges in implantable devices such as neural probes, artificial vascular sensors, and electronic sutures. In particular, for implantable devices, all materials used should be non-toxic and biocompatible. Accordingly, to evaluate the biocompatibility of the adhesive film (d-HAPT) according to the present disclosure and the adhesive member including the same, in vitro and in vivo experiments were conducted.

### 10.1. In Vitro Experiment

As shown in FIG. 20(a), to conduct an in vitro experiment, a 5×5-mm-thick bare polyimide (PI) and adhesive member 4a (Example 4, Coated PI) including the adhesive film (d-HAPT) according to the present disclosure were prepared. Then, a two-chamber transwell system (8 μm pore size; Corning Inc.) was introduced for cell viability analysis and morphological change analysis. The prepared adhesive member 4a was placed on the insert and incubated with cells throughout the experimental time. In addition, NIH-3T3 fibroblast cells (0.5×10⁵ cells/mL) were cultured in a 6-well cell culture plate containing 1.5 mL of Dulbecco's Modified Eagle's Medium-high glucose (DMEM) supplemented with 10% bovine calf serum and 1% penicillin-streptomycin. Cell viability was evaluated using a Live/Dead kit (L3224, Invitrogen, USA), the intensity of fluorescence cell images was measured using an inverted fluorescence microscope (IX81, Olympus, Japan) with a 10× magnification, and morphological change was measured following the aspect ratio calculation method which is the major cell axis divided by the minor one. For visualization, the cytoskeleton of NIH 3T3 cells was stained using an Alexa 594-conjugated phalloidin (Thermo Scientific, Pittsburgh, PA, USA). The cell morphology was evaluated using a confocal microscope (LSM 980, Carl Zeiss, Oberkochen, Germany) and calculated using the ImageJ/FIJI software program. Based on this, the effect of physiological environmental changes on the cells and the biocompatibility of the material were evaluated, and the results are shown in FIGS. 20(b) and 20(c).

As shown in FIG. 20(b), the results of the live/dead assay and the CCK-8 assay showed no significant differences in cell viability between the bare polyimide (PI) and adhesive member 4a (Example 4, Coated PI) including the adhesive film (d-HAPT) according to the present disclosure after incubation for 1, and 5 days. In addition, as shown in FIG. 20(c), a result of analyzing the fibroblast cell morphology in terms of aspect ratio after TRITC phalloidin staining, it was confirmed that there was no significant difference between bare polyimide (PI) and adhesive member 4a (Example 4, Coated PI) including the adhesive film (d-HAPT) according to the present disclosure.

### 10.2. In Vivo Experiment

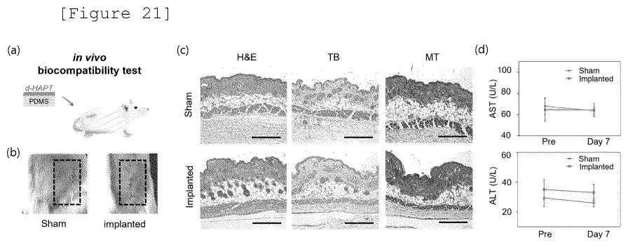

As shown in FIG. 21(a), adhesive member 2 (Example 2, PDMS) including the adhesive film (d-HAPT) according to the present disclosure was subcutaneously implanted into 6-week-old male CD-1 (ICR) mice for 3, 7, and 10 days. The animal experimental protocols were approved by the Institutional Animal Care and Use Committee of Yonsei University College of Medicine (IACUC No. 2023-0097), and all experiments followed the guidelines set by an Association for the Assessment and Accreditation of Laboratory Animal Care (AAALAC)-accredited facility. The mice were housed under 12-hour alternating light/dark cycles and had unrestricted access to food and water. Before the experiment, the mice were anesthetized using ketamine (100 mg/kg) and Rompum (10 mg/kg). Mice were purchased from Orient Bio Incorporation, Seongnam, Korea.

For histological evaluation, adhesive member 2 (Example 2, PDMS) including the adhesive film (d-HAPT) according to the present disclosure was implanted into mice, and the mice were euthanized after 3 and 7 days. Then, the implants and surrounding skin tissues were extracted and preserved in 10% formalin (Sigma-Aldrich, St. Louis, USA). The preserved tissues were processed using ASP300S (Leica Biosystems, Nussloch, Germany), and then embedded in paraffin blocks (Histo Core Arcadia, Leica Biosystems). Tissue samples were then sectioned to a thickness of 4 μm, and the sections were mounted onto slides (RM2255, Leica Biosystems) and then subjected to histological staining with hematoxylin-eosin (H&E), toluidine blue (TB), and Masson's trichrome (MT). The results are shown in FIGS. 21(b) to 21(d).

As shown in FIG. 21(b) and FIG. 21(c), the results of histological staining using hematoxylin-eosin (H&E), toluidine blue (TB), and Masson's trichrome (MT) staining on the back of the mouse implanted with the adhesive member 2 including the adhesive film (d-HAPT) according to the present disclosure showed that the implanted sample did not trigger significant inflammatory responses or necrosis of surrounding tissues and a noticeable increase in collagen deposition.

Based on this, to assess any hepatotoxicity caused by the adhesive film (d-HAPT) according to the present disclosure, blood samples were drawn through retro-orbital bleeding before and 3, 7, and 10 days after implantation of adhesive member 2 (Example 2, PDMS) (n=4). The drawn blood was collected in heparinized capillary tubes (Micro-Hematocrit Capillary Tube Plain, Kimble Chase, Vineland, NJ, USA) and left to clot in a serum separation tube (BD Microtainer, BD, Franklin Lakes, NJ, USA) at room temperature for 2 hours. Then, the blood samples underwent centrifugation at 300 g for 15 min, followed by 10 min at 600 g twice, and then the supernatant serum was extracted and stored at −80° C. Levels of AST and ALT in the serum were determined using a Dri-Chem 4000i biochemical analyzer (Fujifilm, Tokyo, Japan), and the results are shown in FIG. 21(d).

As shown in FIG. 21(d), there was no significant change in the serum levels of AST and ALT between the group implanted with adhesive member 2 (Example 2, PDMS) including the adhesive film (d-HAPT) according to the present disclosure and the control group that was not implanted with adhesive member 2, suggesting that the implantation did not trigger hepatotoxicity.

The above results suggest that the adhesive film according to the present disclosure and the adhesive member including the same have excellent biocompatibility and thus are actually applicable in vivo in various fields.

### Experimental Example 11. Implantable Bioelectronic Device Applications

Considering that the adhesive film according to the present disclosure and the adhesive member including the same showed biocompatibility in in vitro and in vivo experiments, an implantable bioelectronic device was fabricated to evaluate whether the adhesive film (d-HAPT) according to the present disclosure can be used as an adhesive in implantable bioelectronics applications.

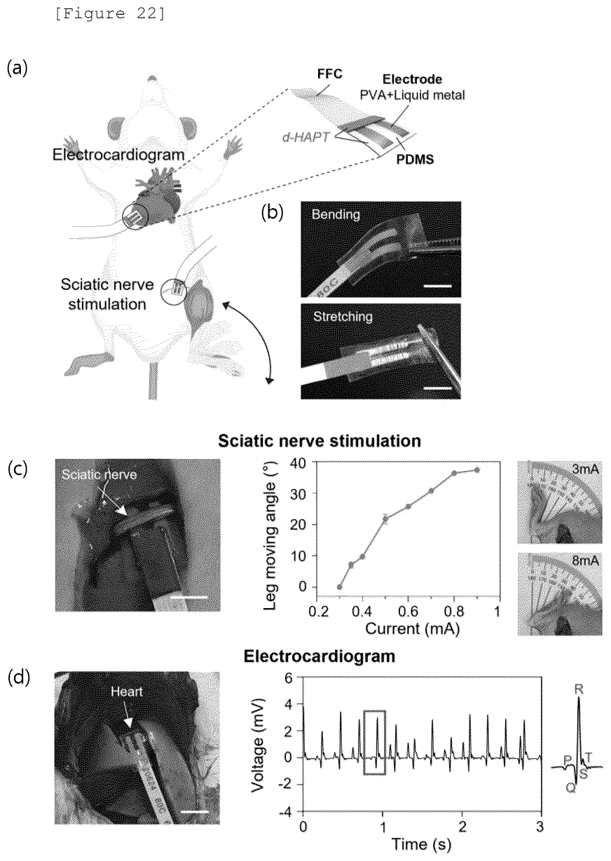

As shown in FIG. 22(a), the implantable bioelectronic device was fabricated by spray-printing a PVA-liquid metal composite of 3 g of liquid metal (75% gallium and 25% indium) and 2 ml of PVA solution (5 wt %) on adhesive member 2 (Example 2, PDMS) including the adhesive film (d-HAPT) according to the present disclosure to form stretchable hydrogel electrodes. The fabricated implantable bioelectronic device was implanted into 12-week-old female Sprague-Dawley rats (Koatech, Korea), wherein the rats were anesthetized with isoflurane (5% for induction and 2% for maintenance). A heating pad was used to maintain the body temperature of the rat, and all surgical procedures for rats were performed in accordance with protocols approved by the Institutional Animal Care and Use Committee (IACUC) at Korea Advanced Institute of Science and Technology (KAIST). The bending and stretching forces of the implanted device were measured, and the ability of neuromodulation on the rat sciatic nerve and the ability of electrocardiogram conduction were evaluated. The results are shown in FIGS. 22(b) to 22(d).

As shown in FIG. 22(b), it can be confirmed that the implantable bioelectronic device implanted in the rat body was firmly integrated despite the application of external forces, such as bending or stretching deformation.

In addition, as shown in FIG. 22(c), it can be confirmed that, as the stimulation was applied to the rat implanted with the implantable bioelectronic device, the leg of the rat responded while showing different moving angle upon an increase in the applied current.

In addition, as shown in FIG. 22(d), it can be seen that P wave, QRS complex, and T wave, which play a vital role in diagnosing various cardiac disorders, were distinctly confirmed through the analyzed signal.

Based on this, it can be seen that the adhesive film (d-HAPT) according to the present disclosure and the adhesive member including the same stably integrated the soft electronic devices even during the intense movement of the leg and heart due to their excellent adhesiveness.

Form the above results, it can be seen that the adhesive film according to the present disclosure and the adhesive member including the same may be applied in various fields due to their strong adhesiveness.

While the present disclosure has been described with reference to the particular illustrative embodiments, it will be understood by those skilled in the art to which the present disclosure pertains that the present disclosure may be embodied in other specific forms without departing from the technical spirit or essential characteristics of the present disclosure. Therefore, the embodiments described above should be considered to be illustrative in all respects and not restrictive.

1. An adhesive film comprising:
a first adhesive layer comprising a polyphenol-based compound; and
a composite layer formed on the first adhesive layer,
wherein the composite layer comprises repeating unit consisting of: a resin layer comprising a hydrophilic polymer; and a second adhesive layer formed on the resin layer and comprising a polyphenol-based compound.

2. The adhesive film of claim 1, wherein the composite layer comprises two or more repeating units.

3. The adhesive film of claim 1, wherein hydrogen bonds are formed at an interface between the first adhesive layer and the composite layer, and an interface between the resin layer and the second adhesive layer in the composite layer.

4. The adhesive film of claim 1, wherein the polyphenol-based compound is at least one selected from the group consisting of tannic acid (TA), gallic acid (GA), and flavonoid (Proanthocyanidin).

5. The adhesive film of claim 1, wherein the hydrophilic polymer is at least one selected from the group consisting of polyvinyl alcohol (PVA), gelatin methacryloyl (GelMA), chitosan, and alginate.

6. An adhesive member comprising:
a substrate; and
the adhesive film of claim 1 formed on the substrate,
wherein the adhesive film is positioned such that the first adhesive layer is adjacent to the substrate.

7. The adhesive member of claim 6, wherein the adhesive film is adhered to the substrate by galloyl interaction.

8. A method for fabricating the adhesive member of claim 6, comprising steps of:
forming a first adhesive layer on a substrate by coating with a solution containing a polyphenol-based compound; and
forming a composite layer on the first adhesive layer;
wherein the step of forming the composite layer comprises repeating, once or more, steps of:
forming a resin layer by coating with a solution containing a hydrophilic polymer; and
forming a second adhesive layer on the resin layer by coating with a solution containing a polyphenol-based compound.

9. A bonding method including a step of bonding the adhesive member of claim 6 and a substrate together.

10. The bonding method of claim 9, wherein
the substrate is a dry substrate, and
the step of bonding the dry substrate comprises steps of:
forming the adhesive film on the dry substrate so that the first adhesive layer of the adhesive film is adjacent to the dry substrate;
bonding the dry substrate having the adhesive film formed thereon and the adhesive member together; and
supplying water to a bonding interface between the dry substrate and the adhesive member, followed by heat treatment.

11. The bonding method of claim 10, wherein the dry substrate and the adhesive member are bonded together so that the respective second adhesive layers are adjacent to each other.

12. The bonding method of claim 9, wherein
the substrate is a wet substrate, and
the step of bonding the wet substrate comprises bonding the wet substrate and the adhesive member together so that the respective second adhesive layers are adjacent to each other.

13. A soft device comprising the adhesive member of claim 6.
